(19) United States
(12) Patent Application Publication
(10) Pub. No.: US 2026/0238564 A1
(43) Pub. Date: Aug. 13, 2026

(54) MULTI-AGENTIC IMPAIRMENT RESOLUTION SYSTEM AND METHOD OF USE

(71) Applicant: CABLE TELEVISION LABORATORIES, INC., Louisville, CO (US)

(72) Inventors: Megan H. Collins, Louisville, CO (US); Shafayet Khan, Littleton, CO (US)

(21) Appl. No.: 19/535,483

(22) Filed: Feb. 10, 2026

Related U.S. Application Data
(60) Provisional application No. 63/757,934, filed on Feb. 13, 2025.

(51) Int. Cl. H04L 41/16; G06F 9/54; G06F 40/40; G06N 3/042; H04L 41/046; H04L 41/0686

(52) U.S. Cl. CPC H04L 41/16; G06F 9/547; G06F 40/40; G06N 3/042; H04L 41/046; H04L 41/0686

(57) ABSTRACT

Multi-agentic impairment resolution systems and methods of use are provided. The system includes a proactive network maintenance (PNM) agent configured to determine an impairment, impairment information, and an impairment agentic framework. The system also includes the impairment agentic framework having a first agent and a second agent. The first agent is configured to execute a first tool to perform an agentic RAG process to retrieve repair information from at least one database based on the impairment and impairment information. The second agent is configured to receive the set of instructions and at each step of one or more steps of the set of instructions, identify a third agent based on the step and execute the third agent to execute a corresponding second tool to perform a task based on the step. The set of instructions is performed by the second agent until the impairment is resolved.

### CROSS REFERENCE TO RELATED APPLICATIONS

This application claims the benefit of and priority to U.S. Provisional Application No. 63/757,934, filed on February 13, 2025, which is incorporated herein by reference in its entirety.

### BACKGROUND

The field of the disclosure relates generally to resolving impairments, and more particularly, to resolving impairments using a multi-agentic impairment resolution system.

Generative AI (GAI) provides for the accumulation of knowledge from experts, encodes the knowledge for fast access, and can incorporate situational information to create an equivalence of an expert assistant. More specifically, language models and large language models (LLM) can provide information that is immediately useful to a user. Such GAI and LLMs can be used to, for example provide training for entry level or new employees to a company. However, language models and LLMs do not always provide accurate outputs or answers. In some embodiments, the language models or the LLM may use Retrieval Augmented Generation (“RAG”), which references an external knowledge base to improve the accuracy of the output from the LLM.

RAG is provided as context data which will be used to generate the responses to a given prompt. In this manner, the user has more control of the LLM’s knowledge, can manage its knowledge, can allow for LLMs to search for specific topics, and more. The Retrieval word in RAG describes the capability of retrieving the information needed to augment the response generation.

However, knowledge gaps still exist between the training field technicians receive via corporate or industry training and application of such training when resolving impairments to, for example, a telecommunications network in the field. When such gaps exist, additional field technicians with more experience are sent to the inexperienced field technicians to guide the inexperienced field technician or to rework the impairment. Such mobilization of additional field technicians and potential rework leads to increased costs and time to repair.

### SUMMARY

Embodiments of the present disclosure leverage a multi-agentic impairment resolution system to provide inexperienced field technicians with a step-by-step workflow or set of instructions to accurately and efficiently resolve impairments in the field. The multi-agentic impairment resolution system utilizes a set of agents and tools to perform an agentic RAG process to retrieve expert, standard, or industry-level documents relevant to the impairment and direct task-specific agents and tools to perform steps until the impairment is resolved. The workflow or set of instructions is also adaptable in that subsequent steps can be adjusted based on results of prior steps. Such adaptability may beneficially reduce the number of steps needed and time spent repairing the impairment, and thus increase the efficiency of workflow.

A multi-agentic impairment resolution system according to at least one embodiment of the present disclosure comprises a proactive network maintenance (PNM) agent configured to: receive network metric data; determine an impairment and impairment information based on the network metric data; identify an impairment agentic framework of a plurality of impairment agentic frameworks based on the impairment information to yield an identified impairment agentic framework; and transmit the impairment and impairment information to the identified impairment agentic framework; and the identified impairment agentic framework comprising: a first agent configured to: receive the impairment and impairment information; execute a first tool to perform an agentic RAG process to retrieve repair information from at least one database based on the impairment and impairment information; receive the repair information from first tool; generate a set of instructions for resolving the impairment based on the repair information; and transmit the set of instructions to a second agent; and a second agent configured to: receive the set of instructions; and at each step of one or more steps of the set of instructions, identify a third agent based on the step and execute the third agent to execute a corresponding second tool to perform a task based on the step, wherein subsequent third agents are informed by context provided by prior third agents, wherein the set of instructions is performed by the second agent until the impairment is resolved.

Any of the aspects herein, wherein the tool retrieves real-time telemetry data.

Any of the aspects herein, wherein the impairment is resolved when a difference between the real-time telemetry data and expected data meets or exceeds a predetermined telemetry data threshold.

Any of the aspects herein, wherein the repair information comprises one or more standards documents, one or more specifications, one or more training documents, and one or more expert documents.

Any of the aspects herein, wherein the PNM agent, the first agent, the second agent, and the third agents each comprise a language model and the first tools and the second tools are code-based.

Any of the aspects herein, wherein the tools are code functions, retrievers, or application program interfaces (APIs).

Any of the aspects herein, wherein the multi-agentic impairment resolution system comprises an agentic graph, wherein the PNM agent, the first agent, the second agent, and the third agents are each assigned to an agent node of a plurality of agent nodes in the agentic graph, and wherein the first tools and the second tools are each assigned to a tool node of a plurality of tool nodes in the agentic graph, and the first tools are bound to the second agent and the second tools are bound to the third agents.

Any of the aspects herein, wherein one or more edges connect one or more of agent nodes of the plurality of agent nodes to each other, tool nodes of the plurality of tool nodes to each other, or agent nodes of the plurality of agent nodes to tool nodes of the plurality of tool nodes.

Any of the aspects herein, comprising the at least one database, wherein the at least one database stores one or more documents.

Any of the aspects herein, wherein the first agent and the second agent are integrated.

A method for repairing an impairment using a multi-agentic impairment resolution system according to at least one embodiment of the present disclosure comprises receiving, by a proactive network maintenance (PNM) agent, network metric data; determining, by the PNM agent, an impairment and impairment information based on the network metric data; identifying, by the PNM agent, an impairment agentic framework of a plurality of impairment agentic frameworks based on the impairment information to yield an identified impairment agentic framework; receiving, by a first agent of the identified impairment agentic framework from the PNM agent, the impairment and impairment information; executing, by the first agent, a first tool to perform an agentic RAG process to retrieve repair information from at least one database based on the impairment and impairment information; receiving, by the first agent, the repair information from first tool; generating, by the first agent, a set of instructions for resolving the impairment based on the repair information; receiving, by a second agent of the identified impairment agentic framework from the first agent, the set of instructions; and at each step of one or more steps of the set of instructions, identifying, by the second agent, a third agent based on the step and executing the third agent to execute a corresponding second tool to perform a task based on the step, wherein subsequent third agents are informed by context provided by prior third agents, and wherein the set of instructions is performed by the second agent until the impairment is resolved.

Any of the aspects herein, wherein the tool retrieves real-time telemetry data.

Any of the aspects herein, wherein the impairment is resolved when a difference between the real-time telemetry data and expected data meets or exceeds a predetermined telemetry data threshold.

Any of the aspects herein, wherein the repair information comprises one or more standards documents, one or more specifications, one or more training documents, and one or more expert documents.

Any of the aspects herein, wherein the PNM agent, the first agent, the second agent, and the third agents each comprise a language model and the first tools and the second tools are code-based.

Any of the aspects herein, wherein the tools are code functions, retrievers, or application program interfaces (APIs).

Any of the aspects herein, wherein the multi-agentic impairment resolution system comprises an agentic graph, wherein the PNM agent, the first agent, the second agent, and the third agents are each assigned to an agent node of a plurality of agent nodes in the agentic graph, and wherein the first tools and the second tools are each assigned to a tool node of a plurality of tool nodes in the agentic graph, and the first tools are bound to the second agent and the second tools are bound to the third agents.

Any of the aspects herein, wherein one or more edges connect one or more of agent nodes of the plurality of agent nodes to each other, tool nodes of the plurality of tool nodes to each other, or agent nodes of the plurality of agent nodes to tool nodes of the plurality of tool nodes.

Any of the aspects herein, wherein the at least one database stores one or more documents.

A multi-agentic impairment resolution system according to at least one embodiment of the present disclosure comprises a proactive network maintenance (PNM) agent configured to: receive network metric data; determine an impairment and impairment information based on the network metric data; identify an impairment agentic framework of a plurality of impairment agentic frameworks based on the impairment information to yield an identified impairment agentic framework; and transmit the impairment and impairment information to the identified impairment agentic framework; and the identified impairment agentic framework comprising: an integrated first and second agent configured to perform a step process comprising the operations of: receive the impairment and impairment information; execute a first tool to perform an agentic RAG process to retrieve repair information from at least one database based on the impairment and impairment information; receive the repair information from first tool; generate a step for resolving the impairment based on the repair information; identify a third agent based on the step; and execute the third agent to execute a corresponding second tool to perform a task based on the step, wherein subsequent third agents are informed by context provided by prior third agents, wherein the step process is repeated until the impairment is resolved.

The details of one or more aspects of the disclosure are set forth in the accompanying drawings and the description below. Other features, objects, and advantages of the techniques described in this disclosure will be apparent from the description and drawings, and from the claims.

The preceding is a simplified summary of the disclosure to provide an understanding of some aspects of the disclosure. This summary is neither an extensive nor exhaustive overview of the disclosure and its various aspects, embodiments, and configurations. It is intended neither to identify key or critical elements of the disclosure nor to delineate the scope of the disclosure but to present selected concepts of the disclosure in a simplified form as an introduction to the more detailed description presented below. As will be appreciated, other aspects, embodiments, and configurations of the disclosure are possible utilizing, alone or in combination, one or more of the features set forth above or described in detail below.

Numerous additional features and advantages of the present invention will become apparent to those skilled in the art upon consideration of the embodiment descriptions provided hereinbelow.

### BRIEF DESCRIPTION OF THE DRAWINGS

The accompanying drawings are incorporated into and form a part of the specification to illustrate several examples of the present disclosure. These drawings, together with the description, explain the principles of the disclosure. The drawings simply illustrate preferred and alternative examples of how the disclosure can be made and used and are not to be construed as limiting the disclosure to only the illustrated and described examples. Further features and advantages will become apparent from the following, more detailed, description of the various aspects, embodiments, and configurations of the disclosure, as illustrated by the drawings referenced below.

FIG. 1 is a block diagram of a multi-agentic impairment resolution system according to at least one embodiment of the present disclosure;

FIG. 2A is a dataflow of a multi-agentic impairment resolution system according to at least one embodiment of the present disclosure;

FIG. 2B is another dataflow of a multi-agentic impairment resolution system according to at least one embodiment of the present disclosure;

FIG. 3 is a flowchart according to at least one embodiment of the present disclosure;

FIG. 4 is a flowchart according to at least one embodiment of the present disclosure;

FIG. 5 is a flowchart according to at least one embodiment of the present disclosure;

FIG. 6A shows an example of a computing system, in accordance with one or more embodiments; and

FIG. 6B shows an example of a network, in accordance with one or more embodiments.

### DETAILED DESCRIPTION

The singular forms “a,” “an,” and “the” include plural references unless the context clearly dictates otherwise.

“Optional” or “optionally” means that the subsequently described event or circumstance may or may not occur, and that the description includes instances where the event occurs and instances where it does not.

Approximating language, as used herein throughout the specification and claims, may be applied to modify any quantitative representation that could permissibly vary without resulting in a change in the basic function to which it is related. Accordingly, a value modified by a term or terms, such as “about,” “approximately,” and “substantially,” are not to be limited to the precise value specified. In at least some instances, the approximating language may correspond to the precision of an instrument for measuring the value. Here and throughout the specification and claims, range limitations may be combined and/or interchanged; such ranges are identified and include all the sub-ranges contained therein unless context or language indicates otherwise.

The phrases “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together. When each one of A, B, and C in the above expressions refers to an element, such as X, Y, and Z, or class of elements, such as X₁-Xₙ, Y₁-Yₘ, and Z₁-Zₒ, the phrase is intended to refer to a single element selected from X, Y, and Z, a combination of elements selected from the same class (i.e., X₁ and X₂) as well as a combination of elements selected from two or more classes (i.e., Y₁ and Zₒ).

In the application, ordinal numbers (e.g., first, second, third, etc.) may be used as an adjective for an element (i.e., any noun in the application). The use of ordinal numbers is not to imply or create any particular ordering of the elements, nor to limit any element to being only a single element unless expressly disclosed, such as by the use of the terms “before”, “after”, “single”, and other such terminology. Rather, ordinal numbers distinguish between the elements. By way of an example, a first element is distinct from a second element, and the first element may encompass more than one element and succeed (or precede) the second element in an ordering of elements.

Further, unless expressly stated otherwise, the conjunction “or” is an inclusive “or” and, as such, automatically includes the conjunction “and,” unless expressly stated otherwise. Further, items joined by the conjunction “or” may include any combination of the items with any number of each item, unless expressly stated otherwise.

As used herein, the term “database” may refer to either a body of data, a relational database management system (RDBMS), or to both, and may include a collection of data including hierarchical databases, relational databases, flat file databases, object-relational databases, object-oriented databases, and/or another structured collection of records or data that is stored in a computer system.

As used herein, the terms “processor” and “computer” and related terms, i.e., “processing device”, “computing device”, and “controller” are not limited to just those integrated circuits referred to in the art as a computer, but broadly refers to a microcontroller, a microcomputer, a programmable logic controller (PLC), an application specific integrated circuit (ASIC), and other programmable circuits, and these terms are used interchangeably herein. In the embodiments described herein, memory may include, but is not limited to, a computer-readable medium, such as a random access memory (RAM), and a computer-readable non-volatile medium, such as flash memory. Alternatively, a floppy disk, a compact disc – read only memory (CD-ROM), a magneto-optical disk (MOD), and/or a digital versatile disc (DVD) may also be used. Also, in the embodiments described herein, additional input channels may be, but are not limited to, computer peripherals associated with an operator interface such as a mouse and a keyboard. Alternatively, other computer peripherals may also be used that may include, for example, but not be limited to, a scanner. Furthermore, in the exemplary embodiment, additional output channels may include, but not be limited to, an operator interface monitor.

Further, as used herein, the terms “software” and “firmware” are interchangeable, and include computer program storage in memory for execution by personal computers, workstations, clients, and servers.

As used herein, the term “non-transitory computer-readable media” is intended to be representative of any tangible computer-based device implemented in any method or technology for short-term and long-term storage of information, such as, computer-readable instructions, data structures, program modules and sub-modules, or other data in any device. Therefore, the methods described herein may be encoded as executable instructions embodied in a tangible, non-transitory, computer readable medium, including, without limitation, a storage device and a memory device. Such instructions, when executed by a processor, cause the processor to perform at least a portion of the methods described herein. Moreover, as used herein, the term “non-transitory computer-readable media” includes all tangible, computer-readable media, including, without limitation, non-transitory computer storage devices, including, without limitation, volatile and nonvolatile media, and removable and non-removable media such as a firmware, physical and virtual storage, CD-ROMs, DVDs, and any other digital source such as a network or the Internet, as well as yet to be developed digital means, with the sole exception being a transitory, propagating signal.

As used herein, the term “telecommunication network” refers to a system of interconnected devices connected by links (e.g., cable, fiber, wireless, etc.) over which data can be transmitted between the interconnected devices. The telecommunication network can include, for example, cable networks, hybrid fiber-coaxial networks, fiber networks, a radio frequency network, any wired network, any wireless network, or any hybrid network.

As used herein, the term “agent” is a computer program that can perform tasks autonomously or semi-autonomously on behalf of a user or a system. In other words, the agent can operate independently of a human user or operator. The agent can also perform specialized tasks by using one or more tools. In some embodiments, the agent is a large language model (LLM) that can perform tasks using the one or more tools.

As used herein, the term “tools” is a deterministic computer program that executes a set of codes to produce the same output when given the same input. In other words, the tool performs a task or function specified by the tool’s code.

Furthermore, as used herein, the term “real-time” refers to at least one of the time of occurrence of the associated events, the time of measurement and collection of predetermined data, the time for a computing device (i.e., a processor) to process the data, and the time of a system response to the events and the environment. In the embodiments described herein, these activities and events occur substantially instantaneously.

The person of ordinary skill in the art will understand that the term “wireless,” as used herein in the context of optical transmission and communications, including free space optics (FSO), generally refers to the absence of a substantially physical transport medium, such as a wired transport, a coaxial cable, or an optical fiber or fiber optic cable.

As used herein, the term “data center” generally refers to a facility or dedicated physical location used for housing electronic equipment and/or computer systems and associated components, i.e., for communications, data storage, etc. A data center may include numerous redundant or backup components within the infrastructure thereof to provide power, communication, control, and/or security to the multiple components and/or subsystems contained therein. A physical data center may be located within a single housing facility, or may be distributed among a plurality of co-located or interconnected facilities. A ‘virtual data center’ is a non-tangible abstraction of a physical data center in a software-defined environment, such as software-defined networking (SDN) or software-defined storage (SDS), typically operated using at least one physical server utilizing a hypervisor. A data center may include as many as thousands of physical servers connected by a high-speed network.

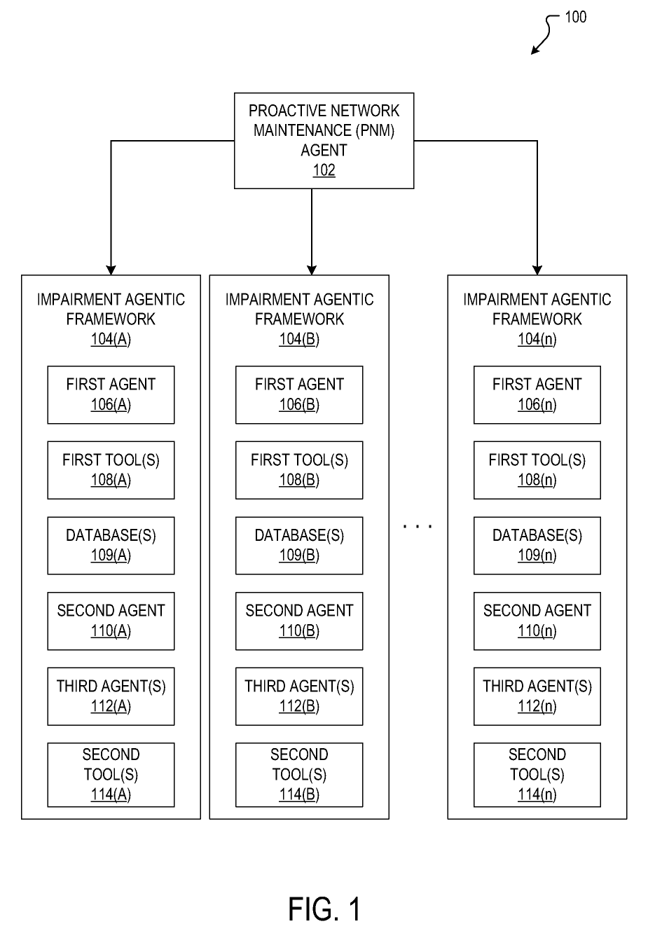

Turning to the Figures, FIG. 1 is a block diagram of a multi-agentic impairment resolution system (100) (also referred to as “the system (100)”) according to at least one embodiment of the present disclosure. The system (100) leverages agentic-AI to provide a user such as, for example, a field technician, adaptive instructions or workflow for resolving impairments in a telecommunication network. More specifically, the system (100) utilizes a network of agents and tools to provide a customized workflow and instructions that are adaptable as the workflow and instructions progresses. Such adaptable and customized workflow can beneficially prevent the need to send additional field technicians to aid an inexperienced field technician and/or to rework the impairment, thereby reducing repair time and costs.

As shown, the system (100) includes a proactive network management (PNM) agent (102). The PNM agent (102) is configured to receive network metric data. The network metric data may be received from, for example, a telecommunication operator’s PNM database. The network metric data may also be received directly from components or devices of the telecommunication network such as, for example, end user equipment, termination systems, etc. The network metric data may include, for example, signal quality, noise levels, and/or distortions.

The PNM agent (102) is also configured to determine an impairment from the network metric data. The impairment can be, for example, upstream noise or a water wave. The impairment information can include the network metric data, a summary of the network metric data, an analysis of the network metric data, and/or a consolidated set of network metric data relevant to the impairment.

The PNM agent (102) is also configured to identify an impairment agentic framework (104) from multiple impairment agentic frameworks (104) based on the impairment and/or impairment information and to transmit the impairment and the impairment information to the identified impairment agentic framework (104).

The system (100) also includes the impairment agentic framework (104). As shown, the impairment agentic framework (104) can include multiple impairment agentic frameworks (104)(A), (104)(B),…to (104)(n). In other words, there can be n-number of multiple impairment agentic frameworks (104). Each impairment agentic framework (104) corresponds to an impairment and provides the agents, tools, and databases to generate instructions to repair the impairment. For example, a first impairment agentic framework (104) may correspond to a first impairment (for example, upstream noise) and have agents, tools, and databases specific to repairing the first impairment and a second impairment agentic framework (104) may correspond to a second impairment (for example, water wave) and have agents, tools, and databases specific to repairing the second impairment.

The impairment agentic framework (104) includes a first agent (106). In some embodiments, the first agent (106) may be referred to as a “planner agent”. In some embodiments, the first agent (106) is configured to use and direct first tool(s) (108) to perform agentic retrieval augmented generation (RAG) to retrieve repair information from documents stored in one or more database(s) (109) based on the impairment and impairment information received from the PNM agent (102).

The first agent (106) is also configured to generate instructions having one or more steps to repair the impairment based on the repair information. Each step in the instructions may include a task to perform such as, for example, measure data, retrieve data, perform an operation, instruct a user such as, for example, a field technician, to perform a task, etc.

Generally, agentic RAG provides context data to LLMs (e.g., the first agent) such that when the LLM is generating a response to a prompt, the LLM can augment the response based on the context data. More specifically, during a RAG process, a retriever method can be executed to access the data source where content is stored, find relevant content, and provide such relevant content to the LLM as context.

For example, the first agent (106) can be prompted with the impairment and impairment information and instructions to generate instructions to repair the impairment. The first agent (106) can execute the first tool (108) to perform an agentic RAG process to retrieve documents from the databases (109) that are relevant to the impairment, and provide such retrieved documents (or portions of the documents) to the first agent (106). The first agent (106) can then use the retrieved documents to generate the instructions to repair the impairment based on the retrieved documents.

The impairment agentic framework (104) also includes the first tool(s) (108). The first tools (108) are executed by the first agent (106), as described above. The first tools (108) are retriever tools configured to perform agentic RAG to retrieve repair information from the documents stored in the databases (109) based on the impairment and impairment information. The repair information can include the documents, portions of the documents, or summaries of the document(s) or portions thereof that are relevant to the impairment. The first tools (108) are also configured to transmit the repair information to the first agent (106).

The impairment agentic framework (104) also includes the database(s) (109). The database(s) (109) stores the documents that can be used to obtain repair information. The documents can be any type of document that can be translated to text. For example, the documents can be PDFs, text documents, web pages, videos, audios, images, markdowns, coding files, etc. Each document in the dataset is converted to machine-readable format to enable a RAG process or operation to search the database.

The documents can include, for example, standards and/or specifications, training materials, repair documents, technical papers, best practices documents, troubleshooting workflows, examples of the impairment, maintenance guides, technical journals, etc. that are relevant to the impairment of the impairment agentic framework (104). For example, in embodiments where the impairment is upstream noise, the documents can include example images of upstream noise and/or a standard document that includes troubleshooting information for upstream noise. In another embodiment where the impairment is a water wave, the documents can include images or example data of water waves and/or a standard document that includes troubleshooting information for cable radio frequency spectrum.

The impairment agentic framework (104) also includes a second agent (110). In some embodiments, the second agent (110) may be referred to as a “supervisor agent”. The second agent (110) is configured to receive the instructions from the first agent (106) and perform the steps one at a time. For each step, the second agent (110) determines a third agent (112) and its corresponding second tool(s) (114) to perform a task that satisfies the step. For example, if a step includes instructions to obtain telemetry data from a device in the field, the second agent (110) may determine to use a third agent (112) that can perform the task of retrieving the telemetry data using a second tool (114) that is a retrieval tool.

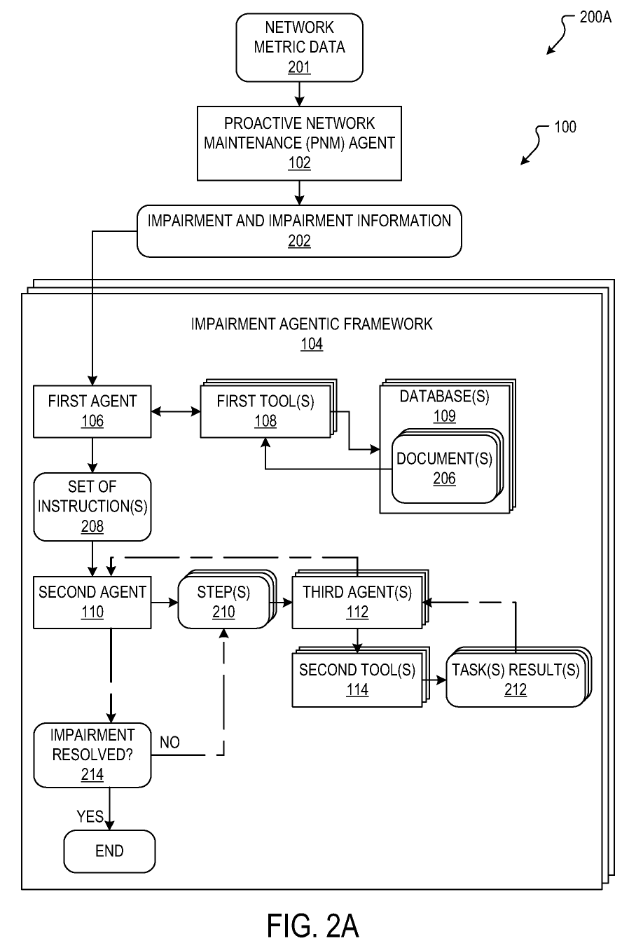

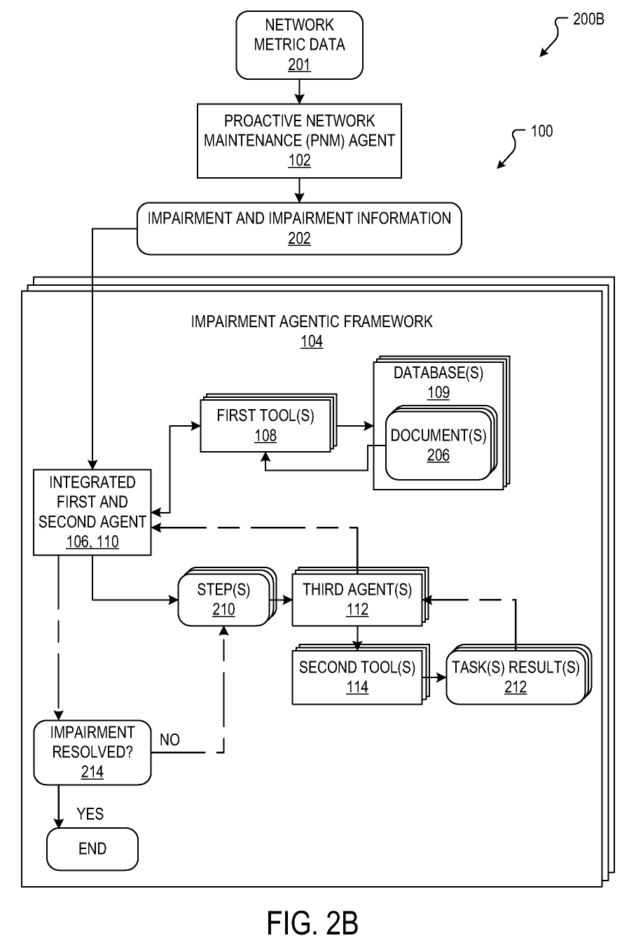

For each step, the third agent (112) is also configured to analyze task results from the second tool (114) and summarize the task results and/or an analysis of the task results. For a subsequent step, the second agent (110) can determine the next third agent (112) based on the summary of the task results and/or analysis of the task results provided by a previous third agent (112). A dataflow illustrating use of the system (100) with a separated first agent (106) and second agent (110) is shown and described in FIG. 2B.

In alternative embodiments, the second agent (110) and the first agent (106) can be incorporated into the same agent. In such embodiments, the second agent (110) may receive the impairment and the impairment information, perform agentic RAG to retrieve repair information from the databases (109) based on the impairment and impairment information, and determine a step of one or more steps to repair the impairment. The second agent (110) may then use the step to identify a third agent (112) to perform a task of the step.

After the step is completed, the second agent (110) may perform a subsequent agentic RAG to retrieve repair information from the database (109) and determine a subsequent step. The second agent (110) may then determine a subsequent third agent (112) to perform a subsequent task of the subsequent step. In other words, rather than generate instructions at one time (by, for example, a separate first agent (106)), the second agent (110) may determine a step and a third agent (112) to perform a task for the step one step at a time. The second agent (110) may also use task results of previous steps to determine a next step and next third agent (112). A dataflow illustrating use of the system (100) with an integrated first agent and second agent (106, 110) is shown and described in FIG. 2B.

The impairment agentic framework (104) also includes third agents (112). The third agents (112) are agents that are defined to perform a task with a corresponding second tool (114) to repair the impairment associated with the impairment agent framework (104). The third agents (112) are also optionally configured to summarize and/or analyze results of the second tool (114) performing the task.

For example, in embodiments where the impairment is upstream noise, the third agents (112) may include agents configured to execute corresponding second tools (114) to determine an impairment direction, check a ground block f-connector, check a premise f-connector, etc. Whereas in embodiments where the impairment is a water wave, the third agents (112) may include agents configured to execute corresponding second tools (114) to measure a tap measurement, to measure a ground block, to retrieve impairment signatures, etc.It will be appreciated that the impairment agent framework (104) can include any number of third agents (112) to direct and execute second tools (114) to perform tasks associated with the impairment.

The impairment agentic framework (104) also includes the second tool(s) (114). The second tools (114) are executed by corresponding third agents (112). The second tools (114) are tools that are defined and programmed to perform a task as directed by the second tool’s (114) corresponding third agent (112). The second tools (114) also transmit task results to the corresponding third agents (112).

For example, in embodiments where the impairment is upstream noise, the second tool (114) may include tools configured to determine an impairment direction, check a ground block f-connector, check a premise f-connector, etc. Whereas in embodiments where the impairment is a water wave, the second tools (114) may include tools configured to measure a tap measurement, to measure a ground block, to retrieve impairment signatures, etc.

The second tools (114) can also, for example, obtain network data in real-time. Such network data can be used by the second agent (110) to determine the next step and/or whether the impairment has been resolved. The second tools (114) can also provide instructions for a user such as, for example, a technician to perform a task and/or to input results of performing the task or to confirm that the task has been performed. Similarly, the second tools (114) can invoke other tools to complete a task.It will be appreciated that the impairment agent framework (104) can include any number of second tools (114) to perform tasks associated with the impairment.

In some embodiments, the system (100) is an agentic graph. More specifically, the system (100) is a directed acyclic graph (DAG) that can provide controls over how the agents (e.g., the PNM agent (102), the first agent (106), the second agent (110), the third agent (112)) interact with each other and how the agents can communicate with each other. It will be appreciated that in other embodiments, the system (100) can be any type of graph.

Generally, the DAG includes nodes that are connected by edges. The nodes represent the agents (e.g., the PNM agent (102), the first agent (106), the second agent (110), the third agent (112)) or the tools (e.g., first tools (108), second tools (114)) and edges represent connections between the different nodes. In other words, the DAG can include agent nodes and tool nodes and edges between agent nodes and/or tool nodes represent connections between the different agent nodes and/or tool nodes. For example, an agent node corresponding to the third agent (112) may be connected to a corresponding second tool (114) via an edge connection. In another example, an agent node corresponding to the first agent (106) may be connected to another agent node corresponding to the second agent (110) via an edge connection.

The DAG also includes an internal state that can aid in coordinating the flow of interactions between the agents and provides agents access to the results or data from other agents and their tools without needing to repeat the work to obtain those results or data. The internal state can also maintain conversations and messages between various agents and/or tools that can be referenced or accessed by the various agents.

FIG. 2A is a dataflow (200A) of the multi-agentic impairment resolution system (100) according to at least one embodiment of the present disclosure. As previously described, the dataflow (200A) illustrates the system (100) with a separate first agent (106) and second agent (110).

As shown, the dataflow (200A) begins with the PNM agent (102) receiving network metric data (201). As previously described, the network metric data (201) may be received from, for example, a telecommunication network’s PNM database and may include, for example, signal quality, noise levels, and/or distortions. The PNM agent (102) uses the network metric data (201) to determine an impairment and impairment information (202). For example, the PNM agent (102) may determine that the impairment is upstream noise based on signal quality and noise levels.

The PNM agent (102) then identifies an impairment agentic framework (104) from multiple impairment agentic frameworks (104) based on the impairment and the impairment information (202). As previously described, each impairment agentic framework (104) corresponds to an impairment. Thus, continuing the previous example where the impairment is upstream noise, the PNM agent (102) identifies the impairment agentic framework (104) that correlates to the impairment of upstream noise.

The PNM agent (102) then transmits the impairment and impairment information (202) to a first agent (106) of the identified impairment agentic framework (104). The first agent (106) executes the first tool (108) to perform an agentic RAG process to retrieve repair information from documents (206) stored in the databases (109) or to retrieve the documents (206) themselves (or relevant portions thereof) based on the impairment and impairment information (202). For example, continuing the previous example where the impairment is upstream noise, the first tool (108) may retrieve repair documents or technical documents for repairing upstream noise.

The first agent (106) receives the retrieved repair information from the first tool (108) and uses the retrieved repair information to generate a set of instructions (208). The set of instructions (208) includes one or more steps (210) to repair the impairment. Each step (210) can include a task to be completed such as, for example, measure data, retrieve data, perform an operation, instruct a user such as, for example, a field technician, to perform a task, etc.

The set of instructions (208) is received by the second agent (110) from the first agent (106). The second agent (110) performs each step (210) of the set of instructions (208) one at a time. At each step (210), the second agent (110) determines a third agent (112) of multiple third agents (112) that can perform the task of the step (210) and executes or directs the third agent (112) to perform the task. The third agent (112), when executed or directed by the second agent (110), executes or directs a corresponding second tool (114) to perform the task.

The corresponding second tool (114) then outputs task results (212) to the third agent (112), which the third agent (112) can transmit to the second agent (110) (shown in elongated dash lines). Alternatively, or additionally, the third agent (112) can summarize and/or analyze the task results (212) and transmit the summarized task results to the second agent (110) (also shown in elongated dash lines). The second agent (110) then determines if the impairment is resolved (214) based on the task results (212) or summarized task results (also shown in elongated dash lines). If the impairment is resolved (214) or a set number of steps have been performed, then the dataflow (200A) ends. If the impairment is not resolved (214), then the second agent (110) performs the next step (210) and determines the next third agent (112) to perform the next step (210).

In some embodiments, a step (210) can include multiple steps (210) or tasks performed by the second agent (110). In such embodiments, the second agent (110) can identify one or more third agents (112) to complete multiple tasks. For example, a task can include “replace a water-soaked drop cable and measure a meter at a ground block to confirm that the impairment has been successfully resolved.” In such example, the second agent (110) would identify and execute two third agents (112) in sequence or in parallel. Once both third agents (112) have completed their execution, both third agents (112) would provide their task results (212) to the second agent (110). The second agent (110) would then use the task results (212) or summarized task results (212) and/or analysis of the task results (212) to determine subsequent third agents (112) for subsequent steps (210). In another example, one third agent (112) can be identified to perform both tasks of “replace a water-soaked drop cable and measure a meter at a ground block to confirm that the impairment has been successfully resolved.” In such example, the third agent (112) can perform the tasks in parallel or sequentially.

FIG. 2B is a dataflow (200B) of the multi-agentic impairment resolution system (100) according to at least one embodiment of the present disclosure. As previously described, the dataflow (200B) illustrates the system (100) with an integrated first and second agent (106, 110).

Generally, the dataflow (200B) is the same as the dataflow (200A) and begins with the PNM agent (102) receiving the network metric data (201). Also, similarly to the dataflow (200A), the dataflow (200B) includes the PNM agent (102) determining the impairment and impairment information (202) and identifying an impairment agentic framework (104) based on the impairment and impairment information (202).

The impairment and impairment information (202) is transmitted to an integrated first and second agent (106, 110). Different from the dataflow (200A), the dataflow (200B) includes generating each step (210) individually by the integrated first and second agent (106, 110) and performing the step (210) before generating a subsequent step (210). More specifically, the integrated first and second agent (106, 110) directs the first tool (108) to perform an agentic RAG process to retrieve repair information from documents (206) stored in the databases (109) or to retrieve the documents (206) themselves (or relevant portions thereof) based on the impairment and impairment information (202).

More specifically, the integrated first and second agent (106, 110) uses the repair information to generate a step (210). The integrated first and second agent (106, 110) then determines a third agent (112) of multiple third agents (112) that can perform a task of the step (210). The integrated first and second agent (106, 110) directs the third agent (112) to perform the task. The third agent (112) then executes or directs a corresponding second tool (114) to perform the task and the second tool (114) outputs task results (212) based on the task performed.

The corresponding second tool (114) then outputs task results (212) to the third agent (112), which the third agent (112) can transmit to the integrated first and second agent (106, 110) (shown in elongated dash lines). Alternatively, or additionally, the third agent (112) can summarize and/or analyze the task results (212) and transmit the summarized and/or analyzed task results to the integrated first and second agent (106, 110) (also shown in elongated dash lines). The integrated first and second agent (106, 110) then determines if the impairment is resolved (214) based on the task results (212) or summarized task results (also shown in elongated dash lines). If the impairment is resolved (214) or a set number of steps have been performed, then the dataflow (200B) ends.

If the impairment is not resolved (214), the integrated first and second agent (106, 110) directs the first tool (108) to perform a subsequent agentic RAG process to retrieve subsequent repair information from documents (206) stored in the databases (109) or to retrieve the documents (206) themselves (or relevant portions thereof) based on the impairment and impairment information (202) and/or the task results (212) (or summaries and/or analysis thereof). The integrated first and second agent (106, 110) uses the subsequent repair information and/or task results (212) to generate a subsequent step (210). The integrated first and second agent (106, 110) then determines a subsequent third agent (112) that can perform a subsequent task of the subsequent step (210). The integrated first and second agent (106, 110) directs the subsequent third agent (112) to perform the subsequent task.

The subsequent third agent (112) executes or directs a corresponding subsequent second tool (114) to perform the subsequent task and the subsequent second tool (114) outputs subsequent task results (212) based on the subsequent task performed. The corresponding subsequent second tool (114) then outputs subsequent task results (212) or a summarized subsequent task results (212) to the subsequent third agent (112), which the subsequent third agent (112) can transmit to the integrated first and second agent (106, 110). The integrated first and second agent (106, 110) then determines if the impairment is resolved (214) based on the subsequent task results (212) or summarized task results.

As described above, the integrated first and second agent (106, 110) can repeat the process of generating and performing subsequent steps (210) until the impairment is resolved or a set number of steps have been performed. Each subsequent step (210) can be determined based on information from prior steps (210) such as, for example, third agents (112) and second tools (114) used in prior steps (210), task results (212) from prior steps (210), and/or summaries or analysis of task results (212) from prior steps (210).

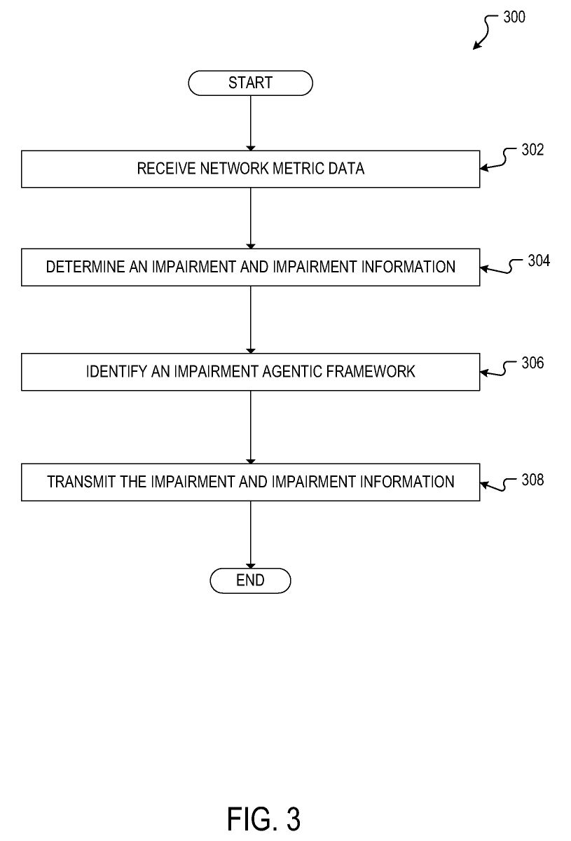

Turning to FIGS. 3, 4, and 5, a method (300) of the PNM agent (102), a method (400) of the first agent (106), and a method (500) of second agent (110) are respectively shown. Each of the methods (300), (400), (500) can be executed using, for example, a multi-agentic impairment resolution system such as the multi-agentic impairment resolution system (100) described in FIGS. 1, 2B, and 2C.

FIG. 3 is a flowchart of a method (300) according to at least one embodiment of the present disclosure. The method (300) are steps or operations that a PNM agent such as the PNM agent (102) can execute to determine an impairment and identify a corresponding impairment agentic framework suitable to generate instructions to repair the impairment.

Step 302 of the method (300) provides for receiving network metric data. The network metric data is the same as or similar to the network metric data (201) and includes, for example, signal quality, noise levels, and/or distortions.

Step 304 of the method (300) provides for determining an impairment and impairment information. The impairment and impairment information is the same as or similar to the impairment and impairment information (202). The impairment information can include the network metric data as received, or a summary of the network metric data. The impairment information can also include an analysis of the network metric data, or a summary of said analysis.

The impairment can be determined based on the analysis of the network metric data. For example, the PNM agent may determine that the impairment is upstream noise based on signal quality and noise levels. In the same example, the PNM agent may determine that the signal quality and noise levels match or are similar to signal quality and noise levels of known upstream noise.

Step 306 of the method (300) provides for identifying an impairment agentic framework. The impairment agentic framework may be the same as or similar to the impairment agentic framework (104). The impairment agentic framework can be identified based on, for example, matching the impairment determined from the network metric data to the impairment corresponding to the impairment agentic framework.

Step 308 of the method (300) provides for transmitting the impairment and impairment information. The impairment and impairment information is transmitted to the impairment agentic framework identified in step 306. Execution of the impairment agentic framework is described below.

The method (300) described in FIG. 3 can include more or less steps. One or more steps or any combination of steps may also be repeated in the method described in FIG. 3.

Step 402 of the method (400) provides for receiving impairment and impairment information. The impairment and impairment information may be received from the PNM agent of the method (300).

Step 404 of the method (400) provides for executing a first tool to perform an agentic RAG. The first tool may be the same as or similar to the first tool (108) and may be retriever tools configured to perform the agentic RAG. The first tools, in response to the first agent directing or executing the first tool, perform an agentic RAG process to retrieve repair information from documents such as the documents (208) stored in databases such as the databases (109) based on the impairment and impairment information.

Step 406 of the method (400) provides for receiving repair information. The repair information is received from the first tool by the first agent or the integrated first and second agent. As previously described, the repair information can include the documents, portions of the documents, or summaries of the document(s) or portions thereof that are relevant to the impairment.

Step 408 of the method (400) provides for generating a set of instructions. The set of instructions is generated by the first agent based on the received repair information. The set of instructions includes one or more steps for repairing the impairment and each step includes a task.

In some embodiments, step 408 is optional (indicated by dashed lines) when, for example, the method (400) is performed by the integrated first and second agent.

Step 410 of the method (400) provides for transmitting the set of instructions. The set of instructions are transmitted to a second agent such as the second agent (110). Execution of the second agent is described below. It will be appreciated that step 410 is optional (indicated by dashed lines) in embodiments where the method (400) is performed by the integrated first and second agent.

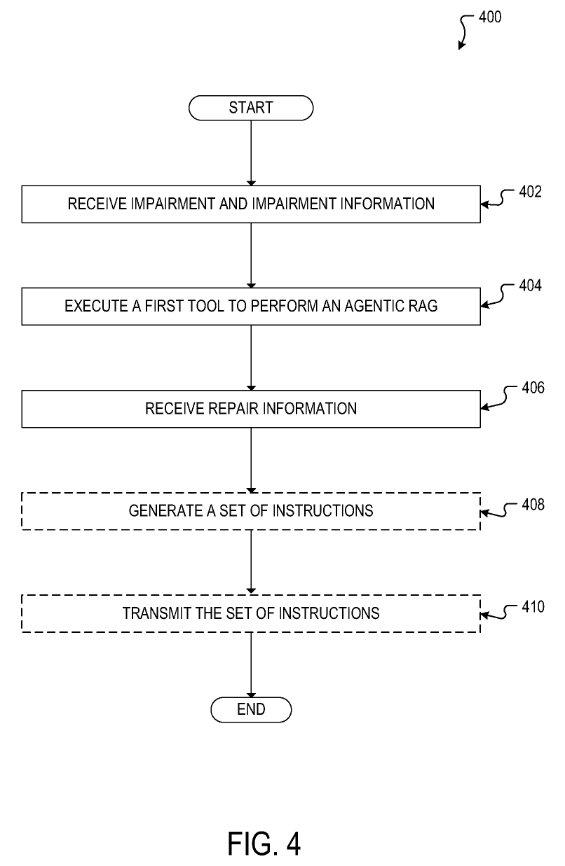

The method (400) described in FIG. 4 can include more or less steps. One or more steps or any combination of steps may also be repeated in the method described in FIG. 4.

Step 502 of the method (500) provides for receiving a set of instructions. The set of instructions is received by the second agent from the first agent of the method (400). As previously described, the second agent performs each step of the set of instructions one step at a time. In other words, steps 504, 506, 508, and 510 as described below are repeated for each step of the set of instructions until the impairment is resolved or a set number of steps have been performed.

It will be appreciated that step 502 is optional (indicated by dashed lines) in embodiments where the method (500) is performed by the integrated first and second agent. In such embodiments, the integrated first and second agent determines a step to perform based on the repair information received in step 406 of the method (400) described above.

Step 504 of the method (500) provides for, for each step, identifying a third agent based on the step. The third agent may be the same as or similar to the third agent (112). The third agent is configured to perform a task by directing or executing a corresponding second tool such as the second tool (114). The third agent is identified by the second agent or the integrated first and second agent based on the task of the step. In other words, the second agent or the integrated first and second agent determines a third agent that is configured to perform the task of the step.

Step 506 of the method (500) provides for directing the third agent to execute a corresponding second tool to perform the task. The task can include, for example, obtain network data in real-time, obtain network data, provide instructions for a user such as, for example, a technician to perform a task, input results of performing the task, and/or confirm that the task has been performed.

Step 508 of the method (500) provides for receiving task results. The task results may be the same as or similar to the task results (212). The task results can be transmitted to the third agent by the second tool and the third agent can transmit the task results directly to the second agent or the integrated first and second agent. Alternatively, or additionally, the third agent can summarize and/or analyze the task results and send such summaries and/or analysis to the second agent or the integrated first and second agent.

Step 510 of the method (500) provides for determining if the impairment is resolved based on the task results. Determining if the impairment is resolved may include, for example, comparing the task results or a difference of the task results and an expected result to a predetermined threshold. In the same example, the impairment may be determined to be resolved when the difference is less than the predetermined threshold, and the impairment may not be determined to be resolved when the difference meets or exceeds the predetermined threshold.

For example, a difference between real-time network data collected by the second tool and expected network data can be compared to a predetermined threshold to determine if the real-time network is the same as or similar to the expected network data. A difference that is lower than the predetermined threshold can indicate that the real-time network data and the expected network data are similar to each other and thus, the impairment is resolved. Conversely, a difference that meets or exceeds the predetermined threshold can indicate that the real-time network data and the expected network data are dissimilar and thus, the impairment is not resolved. In still other embodiments, other forms of analysis may be used to determine if the impairment is resolved.

If the impairment is not resolved, the method (500) returns to step 504 to repeat the method (500) from step 504 until the impairment is resolved, or a set number of steps have been performed. If the impairment is resolved, the method (500) ends.

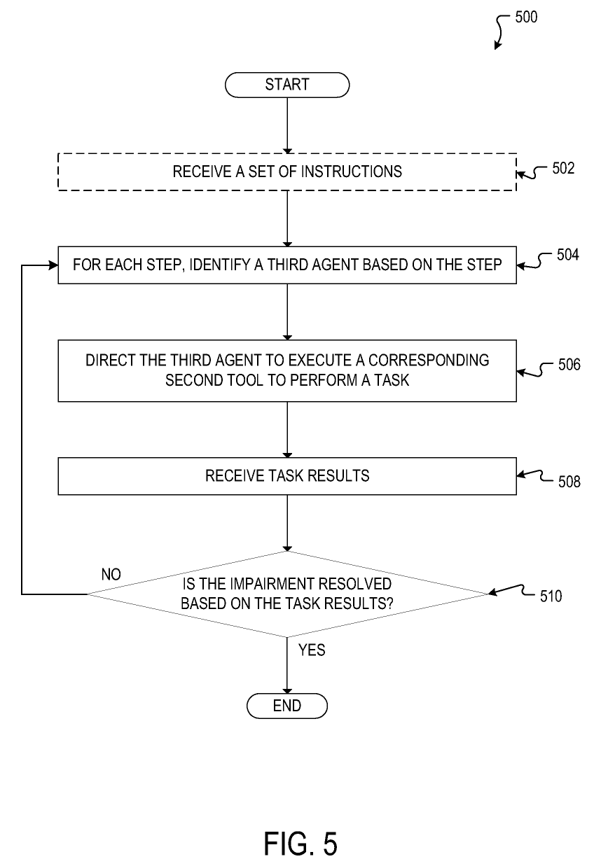

The method (500) described in FIG. 5 can include more or less steps. One or more steps or any combination of steps may also be repeated in the method described in FIG. 5.

One or more embodiments may be implemented on a computing system specifically designed to achieve an improved technological result. When implemented in a computing system, the features and elements of the disclosure provide a significant technological advancement over computing systems that do not implement the features and elements of the disclosure. Any combination of mobile, desktop, server, router, switch, embedded device, or other types of hardware may be improved by including the features and elements described in the disclosure.

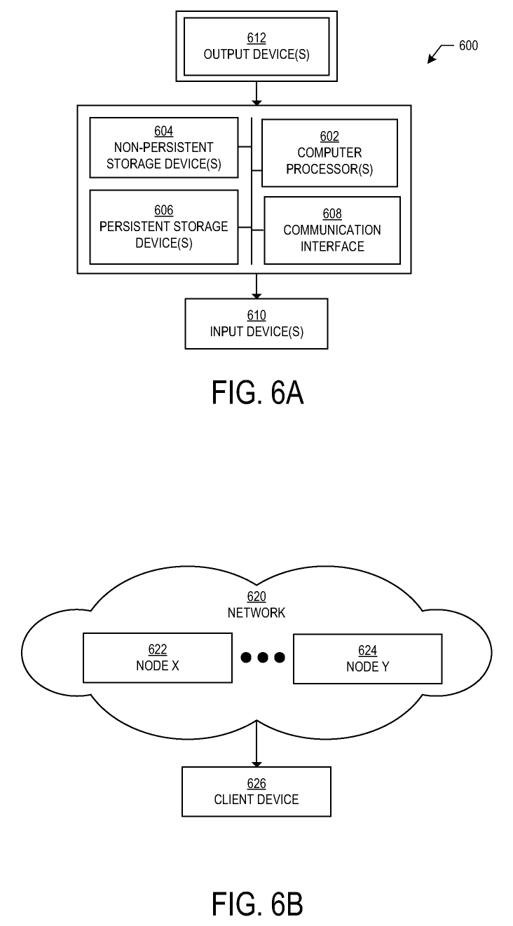

For example, as shown in FIG. 6A, the computing system (600) may include one or more computer processor(s) (602), non-persistent storage device(s) (604), persistent storage device(s) (606), a communication interface (608) (e.g., Bluetooth interface, infrared interface, network interface, optical interface, etc.), and numerous other elements and functionalities that implement the features and elements of the disclosure. The computer processor(s) (602) may be an integrated circuit for processing instructions. The computer processor(s) (602) may be one or more cores, or micro-cores, of a processor. The computer processor(s) (602) includes one or more processors. The computer processor(s) (602) may include a central processing unit (CPU), a graphics processing unit (GPU), a tensor processing unit (TPU), combinations thereof, etc.

The input device(s) (610) may include a touchscreen, keyboard, mouse, microphone, touchpad, electronic pen, or any other type of input device. The input device(s) (610) may receive inputs from a user that are responsive to data and messages presented by the output device(s) (612). The inputs may include text input, audio input, video input, etc., which may be processed and transmitted by the computing system (600) in accordance with one or more embodiments. The communication interface (608) may include an integrated circuit for connecting the computing system (600) to a network (not shown) (e.g., a local area network (LAN), a wide area network (WAN) such as the Internet, mobile network, or any other type of network) or to another device, such as another computing device, and combinations thereof.

Further, the output device(s) (612) may include a display device, a printer, external storage, or any other output device. One or more of the output device(s) (612) may be the same or different from the input device(s) (610). The input device(s) (610) and output device(s) (612) may be locally or remotely connected to the computer processor(s) (602). Many different types of computing systems exist, and the aforementioned input device(s) (610) and output device(s) (612) may take other forms. The output device(s) (612) may display data and messages that are transmitted and received by the computing system (600). The data and messages may include text, audio, video, etc., and include the data and messages described above in the other figures of the disclosure.

Software instructions in the form of computer readable program code to perform embodiments may be stored, in whole or in part, temporarily or permanently, on a non-transitory computer readable medium such as a solid state drive (SSD), compact disk (CD), digital video disk (DVD), storage device, a diskette, a tape, flash memory, physical memory, or any other computer readable storage medium. Specifically, the software instructions may correspond to computer readable program code that, when executed by the computer processor(s) (602), is configured to perform one or more embodiments, which may include transmitting, receiving, presenting, and displaying data and messages described in the other figures of the disclosure.

The computing system (600) in FIG. 6A may be connected to, or be a part of, a network. For example, as shown in FIG. 6B, the network (620) may include multiple nodes (e.g., node X (622) and node Y (624), as well as extant intervening nodes between node X (622) and node Y (624)). Each node may correspond to a computing system, such as the computing system shown in FIG. 6A, or a group of nodes combined may correspond to the computing system shown in FIG. 6A. By way of an example, embodiments may be implemented on a node of a distributed system that is connected to other nodes. By way of another example, embodiments may be implemented on a distributed computing system having multiple nodes, where each portion may be located on a different node within the distributed computing system. Further, one or more elements of the aforementioned computing system (600) may be located at a remote location and connected to the other elements over a network.

The nodes (e.g., node X (622) and node Y (624)) in the network (620) may be configured to provide services for a client device (626). The services may include receiving requests and transmitting responses to the client device (626). For example, the nodes may be part of a cloud computing system. The client device (626) may be a computing system, such as the computing system shown in FIG. 6A. Further, the client device (626) may include or perform all or a portion of one or more embodiments.

The computing system of FIG. 6A may include functionality to present data (including raw data, processed data, and combinations thereof) such as results of comparisons and other processing. For example, presenting data may be accomplished through various presenting methods. Specifically, data may be presented by being displayed in a user interface, transmitted to a different computing system, and stored. The user interface may include a graphical user interface (GUI) that displays information on a display device. The GUI may include various GUI widgets that organize what data is shown, as well as how data is presented to a user. Furthermore, the GUI may present data directly to the user, e.g., data presented as actual data values through text, or rendered by the computing device into a visual representation of the data, such as through visualizing a data model.

As used herein, the term “connected to” contemplates multiple meanings. A connection may be direct or indirect (e.g., through another component or network). A connection may be wired or wireless. A connection may be a temporary, permanent, or a semi-permanent communication channel between two entities.

The foregoing discussion has been presented for purposes of illustration and description. The foregoing is not intended to limit the disclosure to the form or forms disclosed herein. In the foregoing Detailed Description, for example, various features of the disclosure are grouped together in one or more aspects, embodiments, and/or configurations for the purpose of streamlining the disclosure. The features of the aspects, embodiments, and/or configurations of the disclosure may be combined in alternate aspects, embodiments, and/or configurations other than those discussed above. This method of disclosure is not to be interpreted as reflecting an intention that the claims require more features than are expressly recited in each claim. Rather, as the following claims reflect, inventive aspects lie in less than all features of a single foregoing disclosed aspect, embodiment, and/or configuration. Thus, the following claims are hereby incorporated into this Detailed Description, with each claim standing on its own as a separate preferred embodiment of the disclosure.

Moreover, though the description has included description of one or more aspects, embodiments, and/or configurations and certain variations and modifications, other variations, combinations, and modifications are within the scope of the disclosure, i.e., as may be within the skill and knowledge of those in the art, after understanding the present disclosure. It is intended to obtain rights which include alternative aspects, embodiments, and/or configurations to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

What is claimed is:

1. A multi-agentic impairment resolution system, the system comprising:
a proactive network maintenance (PNM) agent configured to:
receive network metric data;
determine an impairment and impairment information based on the network metric data;
identify an impairment agentic framework of a plurality of impairment agentic frameworks based on the impairment information to yield an identified impairment agentic framework; and
transmit the impairment and impairment information to the identified impairment agentic framework; and
the identified impairment agentic framework comprising:
a first agent configured to:
receive the impairment and impairment information;
execute a first tool to perform an agentic RAG process to retrieve repair information from at least one database based on the impairment and impairment information;
receive the repair information from first tool;
generate a set of instructions for resolving the impairment based on the repair information; and
transmit the set of instructions to a second agent; and
a second agent configured to:
receive the set of instructions; and
at each step of one or more steps of the set of instructions, identify a third agent based on the step and execute the third agent to execute a corresponding second tool to perform a task based on the step,
wherein subsequent third agents are informed by context provided by prior third agents,
wherein the set of instructions is performed by the second agent until the impairment is resolved.

2. The multi-agentic impairment resolution system of claim 1, wherein the tool retrieves real-time telemetry data.

3. The multi-agentic impairment resolution system of claim 2, wherein the impairment is resolved when a difference between the real-time telemetry data and expected data meets or exceeds a predetermined telemetry data threshold.

4. The multi-agentic impairment resolution system of claim 1, wherein the repair information comprises one or more standards documents, one or more specifications, one or more training documents, and one or more expert documents.

5. The multi-agentic impairment resolution system of claim 1, wherein the PNM agent, the first agent, the second agent, and the third agents each comprise a language model and the first tools and the second tools are code-based.

6. The multi-agentic impairment resolution system of claim 1, wherein the tools are code functions, retrievers, or application program interfaces (APIs).

7. The multi-agentic impairment resolution system of claim 1, wherein the multi-agentic impairment resolution system comprises an agentic graph, wherein the PNM agent, the first agent, the second agent, and the third agents are each assigned to an agent node of a plurality of agent nodes in the agentic graph, and wherein the first tools and the second tools are each assigned to a tool node of a plurality of tool nodes in the agentic graph, and the first tools are bound to the second agent and the second tools are bound to the third agents.

8. The multi-agentic impairment resolution system of claim 7, wherein one or more edges connect one or more of agent nodes of the plurality of agent nodes to each other, tool nodes of the plurality of tool nodes to each other, or agent nodes of the plurality of agent nodes to tool nodes of the plurality of tool nodes.

9. The multi-agentic impairment resolution system of claim 1, further comprising the at least one database, wherein the at least one database stores one or more documents.

10. The multi-agentic impairment resolution system of claim 1, wherein the first agent and the second agent are integrated.

11. A method for repairing an impairment using a multi-agentic impairment resolution system, the method comprising:
receiving, by a proactive network maintenance (PNM) agent, network metric data;
determining, by the PNM agent, an impairment and impairment information based on the network metric data;
identifying, by the PNM agent, an impairment agentic framework of a plurality of impairment agentic frameworks based on the impairment information to yield an identified impairment agentic framework;
receiving, by a first agent of the identified impairment agentic framework from the PNM agent, the impairment and impairment information;
executing, by the first agent, a first tool to perform an agentic RAG process to retrieve repair information from at least one database based on the impairment and impairment information;
receiving, by the first agent, the repair information from first tool;
generating, by the first agent, a set of instructions for resolving the impairment based on the repair information;
receiving, by a second agent of the identified impairment agentic framework from the first agent, the set of instructions; and
at each step of one or more steps of the set of instructions, identifying, by the second agent, a third agent based on the step and executing the third agent to execute a corresponding second tool to perform a task based on the step,
wherein subsequent third agents are informed by context provided by prior third agents, and
wherein the set of instructions is performed by the second agent until the impairment is resolved.

12. The method of claim 11, wherein the tool retrieves real-time telemetry data.

13. The method of claim 12, wherein the impairment is resolved when a difference between the real-time telemetry data and expected data meets or exceeds a predetermined telemetry data threshold.

14. The method of claim 11, wherein the repair information comprises one or more standards documents, one or more specifications, one or more training documents, and one or more expert documents.

15. The method of claim 11, wherein the PNM agent, the first agent, the second agent, and the third agents each comprise a language model and the first tools and the second tools are code-based.

16. The method of claim 11, wherein the tools are code functions, retrievers, or application program interfaces (APIs).

17. The method of claim 11, wherein the multi-agentic impairment resolution system comprises an agentic graph, wherein the PNM agent, the first agent, the second agent, and the third agents are each assigned to an agent node of a plurality of agent nodes in the agentic graph, and wherein the first tools and the second tools are each assigned to a tool node of a plurality of tool nodes in the agentic graph, and the first tools are bound to the second agent and the second tools are bound to the third agents.

18. The method of claim 17, wherein one or more edges connect one or more of agent nodes of the plurality of agent nodes to each other, tool nodes of the plurality of tool nodes to each other, or agent nodes of the plurality of agent nodes to tool nodes of the plurality of tool nodes.

19. The method of claim 11, wherein the at least one database stores one or more documents.

20. A multi-agentic impairment resolution system, the system comprising:
a proactive network maintenance (PNM) agent configured to:
receive network metric data;
determine an impairment and impairment information based on the network metric data;
identify an impairment agentic framework of a plurality of impairment agentic frameworks based on the impairment information to yield an identified impairment agentic framework; and
transmit the impairment and impairment information to the identified impairment agentic framework; and
the identified impairment agentic framework comprising:
an integrated first and second agent configured to perform a step process comprising the operations of:
receive the impairment and impairment information;
execute a first tool to perform an agentic RAG process to retrieve repair information from at least one database based on the impairment and impairment information;
receive the repair information from first tool;
generate a step for resolving the impairment based on the repair information;
identify a third agent based on the step; and
execute the third agent to execute a corresponding second tool to perform a task based on the step,
wherein subsequent third agents are informed by context provided by prior third agents,
wherein the step process is repeated until the impairment is resolved.
